(19) United States
(12) Patent Application Publication
(10) Pub. No.: US 2020/0311095 A1
(43) Pub. Date: Oct. 1, 2020

(54) SYSTEM AND METHOD FOR AUTOMATED SOURCE CODE GENERATION FOR DATABASE CONVERSION

(71) Applicant: Next Pathway Inc., Toronto (CA)

(72) Inventors: Gregory Gorshtein, Thornhill (CA); Badih Schoueri, Mississauga (CA); Qiang Yu, Richmond Hill (CA)

(21) Appl. No.: 16/820,055

(22) Filed: Mar. 16, 2020

Related U.S. Application Data
(60) Provisional application No. 62/826,645, filed on Mar. 29, 2019.

(51) Int. Cl. G06F 16/25; G06F 16/242; G06F 16/23; G06F 16/2457

(52) U.S. Cl. CPC G06F 16/254; G06F 16/24573; G06F 16/2358; G06F 16/2445

(57) ABSTRACT

A system and method to automatically generate source code for moving and transforming data stored in a source database defined according to a first data model to a target database defined according to a second data model. At least one data mapping expression between the first data model to a conceptual module and at least one mapping and transformation definition between the conceptual model and the second data model are provided. Data Definition Language code is automatically generated for defining the target database based on the at least one data mapping expression and the second data model. Extract, Transform, Load (ETL) code is automatically generated for extracting data from the source database, transforming the data, and loading the transformed data into the target database. The ETL code based on the at least one mapping expression and the at least one mapping and transformation definition.

### TECHNICAL FIELD

The present disclosure relates generally to automated source code generation, and more specifically to a method and system for generating source code for transformation and curation of data.

### BACKGROUND

Big Data is a term for data sets that are so large or complex that traditional data processing applications are inadequate to deal with them. Data sets grow rapidly—in part because they are increasingly gathered by cheap and numerous sources of information, such as sensing devices and networks. The world's technological per-capita capacity to store information has increased phenomenally.

Advancements in cloud-based technologies have enabled the establishment of highly versatile and scalable computing systems. Such systems are highly appealing to business users that desire to operate in Big Data environments. Through collecting and analyzing large amounts of data within such Big Data environments, these business users can identify relevant business insights, from predicting new market trends, to optimizing security and to reaching new demographics.

There are many analytics tools available that are developed for Big Data environments. However, many existing data sets are often stored within databases that may not always be compatible with the preferred analytics tools. Alternatively, the physical data model upon which existing corporate databases are deployed may not provide the efficiencies that enable use of the preferred analytics tools. As such, the data residing within existing databases would need to be migrated to a different physicalized database that would be compatible with such analytics tools.

Traditionally, database migration requires manually writing Extract, Transform, Load (ETL) source code to facilitate migration. But writing ETL code can introduce a number of unknowns including a lack of trust in data due to issues with lineage, and the loss or corruption of associated metadata; high maintenance costs and security risks. While manual ETL creation is tolerable on relatively simple departmental data warehouses, the complexity, cost, time, and opportunities for error that may arise on enterprise-level projects will typically test the efficacy of manual ETL development.

Accordingly, in view of the foregoing deficiencies, there is a need for a system and method to generate ETL code that addresses the above-noted disadvantages of existing ETL generation methods.

### SUMMARY OF THE DISCLOSURE

In general, the present specification describes a system and method to automatically generate Data Definition Language (DDL) and Extract, Transform, Load (ETL) source code to facilitate transformation and curation of data stored in a database physicalized according to a first physical data model to a database physicalized according to a second physical data model.

According to one aspect in the present disclosure, there is provided a method to automatically generate computer source code for moving and transforming data stored in a source database defined according to a first data model to a target database defined according to a second data model. The method includes receiving at least one data mapping expression, each data mapping expression corresponding to mapping and transformation of data in the first data model to a conceptual model; storing at least one mapping and transformation definition that corresponds to mapping and transformation of data between the conceptual model and the second data model; generating Data Definition Language (DDL) code based on the at least one data mapping expression and the second data model; and generating Extract, Transform, Load (ETL) code based on the at least one data mapping expression and the at least one mapping and transformation definition.

In one embodiment, the method further comprises outputting a job execution package comprising the DDL code and ETL code.

In one embodiment, the DDL code is executable by a processor to physicalize the dataset according to the second data model in the target database.

In one embodiment, the ETL code is executable by a processor to cause the processor to extract data stored in the source database, transform the extracted dataset into a structure and format compatible with the target database, transform the data in the dataset in accordance with the business transformation rules in the mapping expressions and load the transformed data to the target database.

In one embodiment, the ETL code defines at least one data transformation to perform on data extracted from the source data base, the data transformation transforming the extracted data into a format and structure that is compatible with the target database.

In one embodiment, the at least one data transformation corresponds to a data transformation expression that is inferable from the at least one data mapping expression and the at least one mapping and transformation definition.

In one embodiment, the method further comprises inserting operational code in to the ETL code to provide versioning and auditing indicators.

According to another aspect of the present disclosure, there is provided a system to automatically generate computer source code for migrating data stored in a source database defined according to a first data model to a target database defined according to a second data model. The system includes a job generation controller for receiving at least one data mapping expression, each data mapping expression corresponding to mapping of data in the first data model to a conceptual model; at least one mapping and transformation definition, that corresponds to mapping and transformation of data between the conceptual model and the second data model; a Data Definition Language (DDL) code generator operable to output DDL code based on at least one data mapping expression and the second data model; and an Extract, Transform, Load (ETL) code generator operable to output ETL code based on the at least one data mapping expression and the at least one mapping and transformation definition.

In one embodiment, the system further comprises a processor to execute at least one of the DDL code and ETL code, wherein execution of the DDL code causes the processor to physicalize the target database according to the second data model and execution of the ETL code causes the processor to extract data stored in the source database, transform the extracted database into a structure and format compatible with the target database, and load the transformed data to the target database.

In one embodiment, the job generation controller is operable to output a job execution package comprising the DDL code and the ETL code.

In one embodiment, the job generation controller activates a metadata service adaptor to receive the at least one data mapping expression from a metadata store.

In one embodiment, the job generation controller receives at least one data mapping expression from a user using a user interface provided by the job generation controller.

In one embodiment, the ETL code generated by the ETL code generator defines at least one data transformation to perform on data extracted from the source database, the data transformation transforming the extracted data into a format and structure that is compatible with the target database.

In one embodiment, at least one data transformation defined in the ETL code corresponds to a data transformation expression that is inferable from the at least one data mapping expression and an the at least one mapping and transformation definition.

In one embodiment, the ETL code generated by the ETL code generator contains operational code executable by a processor to cause the processor to generate versioning and auditing indicators.

Additional aspects of the present invention will be apparent in view of the description which follows.

### BRIEF DESCRIPTION OF THE DRAWINGS

Features and advantages of the embodiments of the present invention will become apparent from the following detailed description, taken with reference to the appended drawings in which:

FIG. 1 is an illustration of the relationship between the conceptual, logical and physical models in data modelling;

FIG. 2 is a block diagram of an automated source code generator system according to at least one embodiment; and

FIG. 3 is a flow chart describing a method to automatically generate a source code package according to at least one embodiment;

### DETAILED DESCRIPTION

The description which follows and the embodiments described therein are provided by way of illustration of examples of particular embodiments of the principles of the present invention. These examples are provided for the purposes of explanation, and not limitation, of those principles and of the invention.

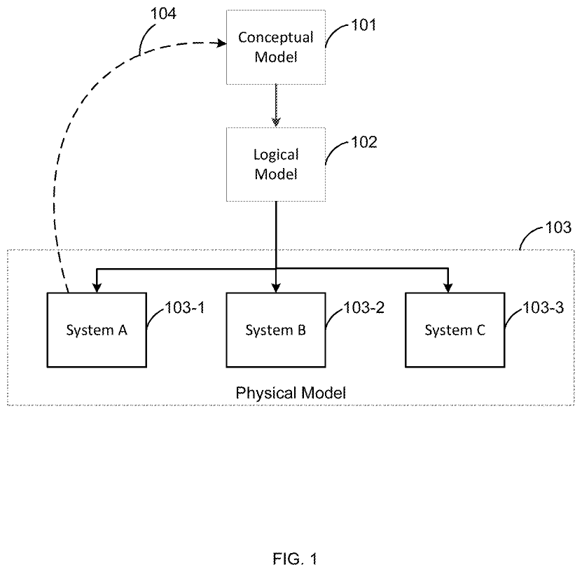

FIG. 1 shows the levels of abstraction that are available to model data. A conceptual model 101 is generally regarded as the most abstract from the technology, providing a high-level description of the data and how they may be related. The conceptual model 101 is intended to communicate the business concepts and rules from a business perspective, rather than from a technical perspective (e.g. datatypes, entities, etc.). The conceptual model 101 uses technology agnostic, business-oriented descriptors/glossaries and describes the desired organization of information. For example, data elements corresponding to a customer can be defined to include a customer name and customer number by business stakeholders at the conceptual level.

A logical model 102 represents a description how the business concepts and rules from the conceptual model 101 should be implemented, without regard to the database system being used. The logical model 102 captures the business concepts and rules provided in the conceptual model 101 and associates specific attributes and structures thereto to allow a better understanding how the business concepts and rules can be organized within data storage systems. Within the logical model 102, data types can be associated with particular business concepts. For example, data elements corresponding to a customer may include a customer name which may be given a string datatype and a corresponding customer identification number can be given an integer data type. It can be appreciated that at the logical model 102, the modelling structure remains generic and agnostic as to the type or configuration of the actual database being used.

A physical model 103 represents an implementation of the data model for a specific database technology and data structure. At this level, the data is organized in accordance with the specific technical specifications of the host database and storage technology having a particular database schema and organized into tables, columns, data types, keys, constraints, permissions, indexes views and other parameters specific to the target database (collectively, “artifacts”) are specifically defined. As illustrated in FIG. 1, the same data represented in the logical model 102 can be “physicalized” or stored in different physical data storage systems, labeled System A 103-1, System B, 103-2 and System C 103-C (collectively “Data Systems”), each system being implemented using a different type of database. For example, System A 103-1 is an SQL database, System B 103-2 is an Apache™ Hive™ distributed database, System C 103-3 is a an IBM™Db2™ database. The database structures between each Data Systems may be incompatible. Further, tools useful for analytics may be available for one database type and not available on another. It is therefore desirable to migrate data from one physical database to another to allow use of these tools.

Existing database implementations generally include a mapping of data between the physical model 103 to the conceptual model 101, as represented by dashed line 104. Migrating data stored within one database to another database often requires the development of suitable Extract, Transform, Load (ETL) source code to enable the migration from one database system to another database system. Additionally, generation of Data Definition Language (DDL) code may further be required prior to migration to deploy the new database if, such a database is not present. Existing code development workflows involve manually create the necessary DDL code and ETL code to facilitate the migration.

Instead of manual ETL development by IT departments or outsourced developers, which is costly, error-prone, inefficient and time-consuming, the present disclosure according to its embodiments curates source data to any business-defined model, while enforcing governance and operational controls—tasks which developers would typically have to manage and deliver.

As discussed in more detail below, disclosed herein is an automatic ETL generation tool, operable to migrate data from one physical data model to another physical data model by generating the desired data movement and physical data model code packages, such as executable jobs and code in the Data Definition Language (DDL), to enable migration of data physicalized (i.e. stored) within a database deployed in accordance to one physical model to another database deployed in accordance to another physical model. More specifically, the generation tool according to embodiments of the present disclosure is intended to automatically generate code packages containing ETL and DDL code, so that that when the code packages are executed by a computer processor of a computing system, the computing system will implement the necessary schema and tables to create a target database according to a target physical data model as selected by a user and move the data from a source database deployed according to a source physical data model to the target database. Upon migration, the data is said to be “physicalized” in the target physical data model. The generated code packages are based on data mappings supplied by the user. The data mappings corresponding to mappings between a given conceptual model and the source physical data model.

For example, banking data stored in a legacy database system can be transformed into a new database system with a different physicalized data model in which useful analytics tools are available. In one use case, banking data such as transactional information can be migrated from a source database and a source physical data model (e.g. IBM™ db2™ database system) to a new database and data model (e.g. Hive™ using the Data Vault modeling methodology). Within the new database, an anti-money laundering (AML) tool such as BAE System™'s NetReveal™, can examine the migrated banking data to identify instances of AML risk or exposure. The generation tool according to embodiments of the present disclosure allows a user to automatically generate code that can transform their data from a non-standard physical data model to a standardized physical data model.

Internally, within the generation tool according to embodiments of the present disclosure, a catalogue of pre-defined relationships and data transformations, including internal mappings, transformation rules, and translations of code expressions between the conceptual model, an intermediate logical model and various target physical data models, is established ahead of time. Pre-defined relationships are established between the conceptual model, the logical model and the target physical model. The data/business transformation rules (e.g. obtainable from the data mapping) indicate how to modify data from a source to a target system as well as a physical target model. The transformation rules reflect the transformations that need to occur to the dataset (structural transformation) and the data (value transformation). According to embodiments of the present disclosure, these defined relationships and transformation rules serve as input to automatically generate the DDL and ETL code used for the data migration. In contrast, the existing approach is to have a business analyst, a data analyst, a data modeler, and an ETL developer all working together to manually generate that ETL code. The catalogue can be updated continuously to add new transformations or update existing transformations. In one embodiment, the generation tool according to embodiments of the present disclosure is configured to select the Data Vault Model as the out-of-the-box chosen target physical data modelling approach. However, other data model physicalization approaches such as Kimball or Inmon can be used.

In view of the foregoing, at a high-level, the generation tool according to embodiments of the present disclosure is operable to receive mappings comprising transformation expressions that describe how to modify the data presently stored in the source database (e.g. de-duplicate similar records, concatenate fields within a record, replace certain values in the fields, join records across datasets, etc.) as well as how the resulting fields map from the physical source database system (i.e. the source database deployed according to a source physical data model) to the conceptual data model. In turn, the generation tool according to embodiments of the present disclosure then uses this information in conjunction with its catalogue of relationships established across the conceptual, logical and physical data models on the target side to automatically infer or identify the corresponding DDL code required to physicalize the target database and the required ETL code to transform and move the data from the source database to the target database. In some embodiments, the generation tool according to embodiments of the present disclosure is further operable to inject operational code to optimize performance, provide auditing and versioning capabilities (e.g. indicators to enable establishment of audit trails and data versions), and implement best practices around data frameworks, such as Slowly Changing

Dimensions and Change Data Capture for example, in the target technology stack. In some embodiments, the operational code can cause the generation of hash values insertable into one or more fields of a database record to indicate the concatenation of specified fields of the record. In other embodiments, timestamps are generated to indicate when the record was created. In yet other embodiments, ETL job execution identifiers are generated to indicate which specific execution of the ETL caused the creation/update of the record. The nature of the operational code can be established, for example, by a project manager or developer via a configuration settings panel, by way of a configuration file or using any other method to configure the operational code known to those in the art. Further details regarding the generation of ETL code is described in greater detail subsequently.

Automating DDL and ETL code generation in such a manner avoids requiring a completely manual development cycle which avoids human error and inconsistencies. It also reduces the development life cycle for generating and testing these transformations by removing steps and resources from the process (e.g. no more ETL developers are required for this step in the data pipeline) As a result, the generation tool according to embodiments of the present disclosure is expected to allow for quick, efficient, and consistent ETL and DDL code generation.

In some cases, certain user-supplied data mappings may be considered “non-standard” or highly customized mappings in which a corresponding transformation is not available within the internal catalogue. As such, some segments of ETL code may still need to be manually provided by developers, depending on the complexity of the transformation. However, generally, the inventors have determined that over 80% of transformations in the data warehouses can be generated through the generation tool according to embodiments of the present disclosure as the complexity is not very high. Transformations created for non-standard mappings may be added to the catalogue for future use.

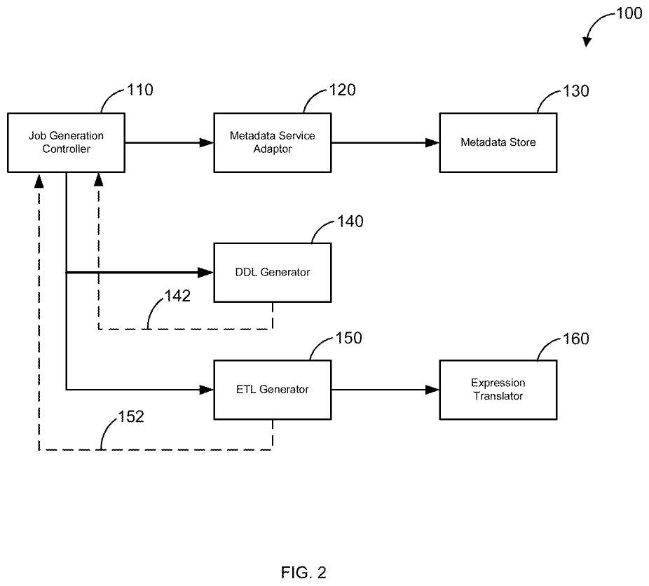

Referring now to the embodiment of FIG. 2, shown therein is a block diagram showing the structure of an embodiment of an automated source code generator system 100. The system can be hosted on a local or on-premises computing system or on a distributed or cloud-based environment located remotely at a data center (e.g. Google Cloud Services or Amazon™ Web Service). As known to those in the art, a cloud-based system may provide scalability in respect of storage memory or computational power. In both cases, the system 100 can be implemented as a server-side application with suitable interfaces to enable communication and data transfer with external hardware and software systems.

The system 100 includes a job generation controller 110 which exposes a software application programming interface (API) to allow external control of the system. The job generation controller 110 can be implemented in various ways. In one example of implementation, the API is implemented based on representational state transfer (REST) technology allowing functionalities of the system 100 to be accessible externally via standard communication protocols such as the HyperText Transfer Protocol (HTTP) over a suitable communication network such as the Internet or a private/proprietary network. Information provided to the system via the job REST API include data mapping of the source database to the conceptual model, the selection of a target database (“source-to-conceptual mappings”), and commands to trigger perform tasks such as generate code for the code package, build the code package or execute the code package. Information regarding data mappings can include the actual mapping such as a mapping file (e.g. plain text file, CSV file, or Microsoft Excel™ spreadsheet) or a data location such as a memory address or a network location as indicated by a uniform resource identifier where the mappings can be extracted. The job generation controller 110 outputs a code package which contains the automatically generated DDL code and ETL code as described in more detail below.

A metadata service adaptor 120 is operable to extract the source-to-target mappings provided by a user that is to be used for the source code generation. In some embodiments, the extraction process can be triggered by receiving a command or signal from the job generation controller 110 to obtain the data mappings. Where a data location is provided, the metadata service adaptor is operable to retrieve the source-to-conceptual mappings from the specified data location. In the present embodiment, the metadata service adaptor 120 is further operable to extract data transformations from a metadata repository such as the metadata store 130. The data transformations correspond to the catalogue transformation and translations of code expressions as noted above used to generate the appropriate code package to deploy target database and migrate the data from the source database to the target database.

In some embodiments, the metadata service adaptor 120 is specific to the metadata store 130. Where the metadata store 130 is deployed using a proprietary or non-standard system (e.g. the IBM™ Governance Catalog) then the metadata service adaptor 120 is specifically configured to communicate and extract the data from the metadata store 130 and further transform the data into a form that can be processed by system 100. The transformation can be made in accordance to a metadata model that is defined ahead of time. In other embodiments, the system 100 can have multiple metadata service adaptors configured for extracting metadata from specific metadata stores. While the metadata service adaptor 120 is depicted as a separate entity in the present embodiment, this component can be integrated into the job generation controller 110 in other embodiments.

A DDL generator 140 is operable to generate the DDL code to enable a computing system to create the physical schema in the target database according to the target database physical model. Alternatively, the DDL code can modify an existing physical target model inside the target database technology. As such, the DDL generator 140 generates DDL code that conforms to the database syntax of the target database technology. For example, DDL code generated by the DDL generator 140 can be MySQL or Apache™ Hive™ code for distributed database systems. Example commands include commands to create tables such as the “CREATE TABLE” command in SQL. In some embodiments, the DDL code generator 140 can be activated to generate DDL code upon receiving a command or signal from the job generation controller 110. The generated DDL code can be provided back to the job generation controller 110, as represented by dashed line 142.

The DDL code is based on the physicalization of the conceptual model noted above to the target physical data model. Using the Data Vault modelling approach which makes use of Hub and Satellite tables, as an example, deciding what data items goes to the Hub table and what goes into the Satellite table can be determined based on naming conventions in the conceptual model. This decision making is reflected in the DDL code.

An ETL generator 150 is operable to generate the ETL code that is executable by a processor of a computing system to carry out the data transformation. More specifically, the ETL code, when executed, allows the computing system to carry out tasks necessary to move and transform the data and structure of the data from a source system and model to a target system and model. First, the computing system extracts data from a source database physicalized according to a source physical data model and system. Next, the computing system transforms said data (where required) into a format and structure that is compatible with the target database physicalized according to the target physical data model and system and according to business transformation rules. For example, the transformation may involve reformatting of ‘date’ entries (e.g. from the DD-MM-YY format to MM-DD-YY format) or merging two customer tables with different structures into a common table. Lastly, the computing system loads/inserts the transformed data into the target database using the target physical data model.

The transformations applied are determined by using the user-supplied source-to-conceptual mappings, the catalogue internal mappings and modelling information linking/relating the conceptual model to the target physical data model. The combination of these two inputs allows the ETL generator 150 to generate suitable ETL code that would enable the computing system executing such code to determine what transformations to apply to the source data and how to physicalize (e.g. to insert/load) the transformed data into the target database established according to the target physical data model. In the present embodiment, the ETL generator 150 uses an expression translator 160 that translates expressions provided in the user-defined source-to-conceptual mappings into suitable ETL code functions. However, in some other embodiments, the expression translator 160 may be integrated with the ETL generator 150. In some embodiments, the ETL code is Scala code for the Apache™ Spark™ distributed computing system. The expression translation 160 would accordingly generate suitable Spark functions. However, other forms of ETL code can be used based on the source and target computing system. For example, the generated ETL code can include, but not limited to, Java, C, or Python. The generated ETL code can be provided back to the job generation controller 110, as represented by dashed line 152.

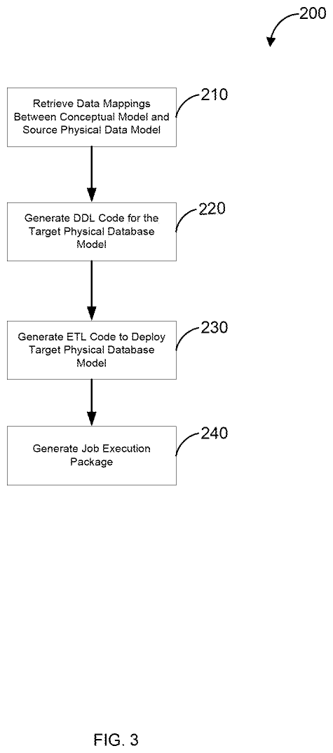

Referring now to FIG. 3, shown therein is a flowchart describing a method 200 carried out by system 100 of FIG. 2 to automatically generate a source code package containing the necessary DDL and ETL code to migrate data from one physical data model to another physical data model.

At step 210, mapping information between the conceptual model and source physical data model is retrieved. As noted previously, the mapping can be provided by way of a mapping file (e.g. plain text, CSV, or Microsoft Excel™ spreadsheet). Alternatively, the mapping information can be stored in a metadata location as noted previously, and represented by metadata store 130. For example, mappings can be provided using tools such as IBM™ FastTrack™ or another suitable system such as IBM™ Governance Catalog (“IGC”). The IBM™ FastTrack™ and IGC tools provide model relationships and data mapping information in the form of metadata. In the system 100 of FIG. 2, such mapping information can be obtained by the metadata service adaptor 120.

The retrieval of data mappings can be triggered, for example, upon the system 100 receiving a command from a user to generate a code package. In one embodiment, the job generation controller 110 receives the command via its REST API. In another embodiment, a user interface (UI) such as web-application interface provided by the job generation controller 110 receives the user command. The command contains at least an indication of the selected target physical data mode and the source of the data mapping.

At step 220, DDL code for target database based on the target physical data model is generated. At this step, the data mappings and an indication of the chosen target physical data model received by the system 100 is used to generate the desired DDL code. More specifically, the mappings indicate the fields and tables defined in the source database according to the source physical data model and inform the DDL generator 140 the corresponding structure of field(s) and table(s) that ought to be created in the target database according to the target physical data model. Based on these mappings, DDL code is generated that would cause the creation of corresponding tables and fields in the target database. For example, the DDL code may include commands to add/drop tables in the target database using functions recognized by database software used to create and maintain the target database. In some embodiments, the DDL generator 140 may use DDL code templates that define/describe commonly used data structures in the target data model. More specifically, the DDL code templates provide a blueprint in the form of skeleton code patterns specific to the source system, the transformation rules and the specified model mappings. The DDL code, when executed, creates the physical schema of the target database according to the target physical data model. The generated DDL code may be provided back to the job generation controller 110.

At step 230, ETL code used to move and transform data from the source database to the target database is generated. As noted above, the ETL code is executable by a processor of a computing system to carry out the data transformation that will be processed and stored in the target physical data model (i.e. as defined in the DDL code generated in the previous step). More specifically, the ETL code, when executed, allows the computing system to carry out tasks necessary to extract the data from the source database, transform the extracted data into a format and structure that is compatible with the target database, and load/insert the transformed data into the target database. Also noted above, the transformations applied are determined using the user-supplied source-to-conceptual mappings and the catalogue of internal mappings/transformations and modelling information linking/relating the conceptual model to the target physical data model. The combination of these two inputs allows the ETL generator 150 to generate suitable ETL code that would enable the computing system executing such code to determine what transformations to apply to the source data and how to physicalize (e.g. to insert/load) the transformed data into the target database established according to the target physical data model.

In the embodiment shown in FIG. 2, the user-supplied source-to-conceptual mappings are parsed by an expression parser (not shown) within the expression translator 160, for example, in a loop until all mapping entries have been parsed. The mappings from the source to conceptual model can take the following forms:
1) src.tbl1.fld1→concept.enty1.attr3;
2) CONCAT(src.tbl1.fld1, src.tbl2.fld3)→concept.enty1.attr4
   Where src means “source”; tbl means “table”; fid means data “field”, enty means “entity” and attr means “attribute”. These mappings form a collection of relationships which maps out conceptual business terminologies to parameters of the source physical database.

Correspondingly, internal mappings and transformations between the entities and attributes of the conceptual model and the fields and tables of the target data model are defined for mapping expressions such as those shown above. The internal mappings and transformations can thus be applied to generate the desired ETL code. The internal mappings and transformations can be stored in suitable data and file formats (e.g. XML, JSON, and the like) for storage and retrieval.

The parsed source-to-conceptual mappings are converted into a format that can be used by the expression translator 160. The expression translator then infers or identifies, based on the user-supplied mappings and corresponding internal mappings and transformations, corresponding data transformation expressions for inclusion in the ETL code. The data transformation expressions are a set of rules to both describe what transformations need to be performed on the data extracted from the source database, as well as mapping rules that map data from the physical data model of the source database (i.e. the structural aspect of the database as opposed to the data values within the database) to the target conceptual model on the source data.

Using this information, the ETL code generator 150 goes through each of the data transformation expressions one by one and outputs the desired ETL code specific to the target physical data model to include such data transformations that will transform and move the data and data structure from the source to the target system. The ETL generator may use ETL code templates that define/describe common data transformations that are used to transform the data into the target data model. Similar to the DDL code templates described above, the ETL code templates provide a blueprint in the form of skeleton code patterns specific to the source system, the transformation rules and the specified model mappings. The generated ETL code is provided back to the job generation controller 110.

At step 240, a job execution package is generated. At this step, the ETL and DDL code is packaged into a “project” or a job as understood by those skilled in the art that can be deployed and executed by a target computing system within the target environment reflecting the user's chosen target physical data model. The code package can be created by the job generation controller 110 or be created under a separate code packaging tool under the control of the job generation controller 110. For example, in the Apache Spark™ framework, a code package can be built using Maven™ from the ETL and DDL code generated by the system 100 for execution in the Apache™ distributed computing environment. The job execution package can further include a code generation report. The report can include a summary of the expressions that have been parsed successfully and transformation expressions that may require additional review by the user, for example, as a result of “non-standard” or highly customized mappings being used that may not have corresponding transformations.

The examples and corresponding diagrams used herein are for illustrative purposes only. Different configurations and terminology can be used without departing from the principles expressed herein.

Although the invention has been described with reference to certain specific embodiments, various modifications thereof will be apparent to those skilled in the art without departing from the scope of the invention. The scope of the claims should not be limited by the illustrative embodiments set forth in the examples, but should be given the broadest interpretation consistent with the description as a whole.

1. A method to automatically generate computer source code for moving and transforming data stored in a source database defined according to a first data model to a target database defined according to a second data model, the method comprising:
receiving at least one data mapping expression, each data mapping expression corresponding to mapping and transformation of data in the first data model to a conceptual model;
storing at least one mapping and transformation definition that corresponds to mapping and transformation of data between the conceptual model and the second data model;
generating Data Definition Language (DDL) code based on the at least one data mapping expression and the second data model; and
generating Extract, Transform, Load (ETL) code based on the at least one data mapping expression and the at least one mapping and transformation definition.

2. The method of claim 1, further comprises outputting a job execution package comprising the DDL code and ETL code.

3. The method of claim 1, wherein the DDL code is executable by a processor to physicalize the dataset according to the second data model in the target database.

4. The method of claim 1, wherein the ETL code is executable by a processor to cause the processor to extract data stored in the source database, transform the extracted dataset into a structure and format compatible with the target database, transform the data in the dataset in accordance with the business transformation rules in the mapping expressions and load the transformed data to the target database.

5. The method of claim 1, the ETL code defines at least one data transformation to perform on data extracted from the source data base, the data transformation transforming the extracted data into a format and structure that is compatible with the target database.

6. The method of claim 5, wherein the at least one data transformation corresponds to a data transformation expression that is inferable from the at least one data mapping expression and the at least one mapping and transformation definition.

7. The method of claim 1, further comprises inserting operational code in to the ETL code to provide versioning and auditing indicators.

8. A system to automatically generate computer source code for migrating data stored in a source database defined according to a first data model to a target database defined according to a second data model, the system comprising:
a job generation controller for receiving at least one data mapping expression, each data mapping expression corresponding to mapping of data in the first data model to a conceptual model;
at least one mapping and transformation definition, that corresponds to mapping and transformation of data between the conceptual model and the second data model;
a Data Definition Language (DDL) code generator operable to output DDL code based on at least one data mapping expression and the second data model; and
an Extract, Transform, Load (ETL) code generator operable to output ETL code based on the at least one data mapping expression and the at least one mapping and transformation definition.

9. The system of claim 8 further comprises a processor to execute at least one of the DDL code and ETL code, wherein execution of the DDL code causes the processor to physicalize the target database according to the second data model and execution of the ETL code causes the processor to extract data stored in the source database, transform the extracted database into a structure and format compatible with the target database, and load the transformed data to the target database.

10. The system of claim 8, wherein the job generation controller is operable to output a job execution package comprising the DDL code and the ETL code.

11. The system of claim 8, wherein the job generation controller activates a metadata service adaptor to receive the at least one data mapping expression from a metadata store.

12. The system of claim 8, wherein the job generation controller receives at least one data mapping expression from a user using a user interface provided by the job generation controller.

13. The system of claim 8, wherein the ETL code defines at least one data transformation to perform on data extracted from the source database, the data transformation transforming the extracted data into a format and structure that is compatible with the target database.

14. The system of claim 13, wherein at least one data transformation corresponds to a data transformation expression that is inferable from the at least one data mapping expression and an the at least one mapping and transformation definition.

15. The system of claim 8, wherein the ETL code contains operational code executable by a processor to cause the processor to generate versioning and auditing indicators.
